(19) United States
(12) Patent Application Publication
(10) Pub. No.: US 2009/0208736 A1
(43) Pub. Date: Aug. 20, 2009

(54) Sized Films

(76) Inventors: Robert Anton Patterson, San Francisco, CA (US); Chris Toshio Seta, San Francisco, CA (US)

Correspondence Address: PETERS VERNY , L.L.P., 425 SHERMAN AVENUE, SUITE 230, PALO ALTO, CA, 94306, US

(21) Appl. No.: 12/034,515

(22) Filed: Feb. 20, 2008

(51) Int. Cl. B32B 7/12; B29C 65/00

(52) U.S. Cl. 428/336; 428/343; 156/60; 156/250

(57) ABSTRACT

An advertising film comprises a media layer and a cover layer. The media layer comprises pigment configured to form a graphic and polymers configured to prevent or reduce discoloration, even when mounted on styrene-butadiene rubber. The cover layer is typically transparent and is configured to help attached the media layer to a surface. The cover layer is optionally larger in area than the media layer. The media layer and the cover layer are optionally attached to the surface using different adhesives. In some embodiments, the medial layer is attached using an adhesive having lower adhesive strength than an adhesive used to attach the cover layer. The media layer and cover layer are optionally attached to a moving surface such as the handrail of a convenience.

### BACKGROUND

1. Field of the Invention

Some embodiments of the invention are in the field of display media and more specifically in the field of advertising display technology.

2. Related Art

Pigmented polymer films are commonly used to display images such as photographs and text. For example, printed polymers films are commonly used in advertising. These printed polymer films can be found in posters, display advertisements, stickers, etc. Polyethylene and polyurethane are two polymers commonly used in advertising applications.

Attempts have been made to add pigmented polymers to conveyance devices such as escalator handrails. See for example, U.S. Pat. Nos. 6,450,228 and 6,682,806. Unfortunately, these handrails often include styrene-butadiene rubber (SBR). It has been found that this and similar rubbers excrete oils that discolor polymer films. There is, therefore, a need for improved systems and methods of displaying media.

### SUMMARY

Embodiments of the invention include a polymer film that resists discoloring when applied to a styrene-butadiene rubber surface. This polymer film includes a material that reduces the porosity of the polymer film. For example, various embodiments include polyvinyl chloride (PVC) at a concentration of greater than 50 percent by weight.

Some embodiments of the invention further include systems and methods of applying this discoloring resistant film to a conveyance. For example, some embodiments include a system that has a media layer comprising a discoloring resistant polymer film and a cover layer comprising a different polymer layer. The media layer and the cover layer are optionally of different widths so as to attach to a moving handrail with minimum folding or distortion of the media layer.

In some embodiments, the media layer and cover layer are configured for easy removal from a conveyance. In these embodiments a different adhesives are optionally used on the media layer and cover layer respectfully. The media layer and cover layer are may include a wide variety of materials and are optionally applied to surfaces other than a conveyance.

Various embodiments of the invention include a system comprising a first film including a pigment, a first polymer and at least 75 percent by weight of polyvinyl chloride, the first film having a width configured to fit between the apex points of an conveyance handrail; and a first adhesive disposed on at least one side of the first film.

Various embodiments of the invention include a system comprising a first film comprising a polymer that is resistant to discoloration by styrene-butadiene rubber; a second film attached to the first film and comprising a polymer that is less resistant to discoloration by styrene-butadiene rubber; and a pigment disposed on the first film or the second film to from a graphic.

Various embodiments of the invention include a method comprising adding at least 75 percent by weight of polyvinyl chloride to a polymer; extruding the polymer and the polyvinyl chloride to form a first film; attaching a second film to the first film, the second film having less than 75 percent by weight of polyvinyl chloride; and adding a pigment to the first film or the second film to form a graphic.

Various embodiments of the invention include a system comprising a first polymer film; a second polymer film attached to the first film, the second polymer film having a width or length that is greater than a width or length of the first polymer film, respectively; a pigment disposed on the first polymer film or the second polymer film; and a first adhesive disposed on at least one side of the first film and configured to removably attach the first film to a mount surface.

Various embodiments of the invention include a method comprising: adding a pigment to a media layer or a cover layer; sizing the media layer to a width configured to fit between apex points of a conveyance handrail; adding a first adhesive to the media layer, the first adhesive configured for the media layer to be removable; sizing a cover layer to a width greater than the width of the media layer; and bonding the media layer and the cover layer.

Various embodiments of the invention include a system comprising a first polymer film having a width between approximately 12.5 cm and 6 cm; a second polymer film attached to the first film, the second polymer film being transparent and having a width greater than the width of the first polymer film; a pigment disposed on the first polymer film or the second polymer film so as to form a graphic; and a first adhesive disposed on at least one side of the first film and configured to removably attach the first film to a conveyance handrail.

Various embodiments of the invention include a system comprising a first film; a first adhesive disposed on a first side of the first film and configured for removal of the first film from a mount surface; a second film including a polymer, disposed on a second side of the first film, and being configured to cover a greater area of the mount surface than the first film; a second adhesive disposed on a first side of the second film, the second adhesive being characterized by a greater adhesion than the first adhesive and being disposed to come in contact with the mount surface; and a pigment disposed on the first film or the second film.

Various embodiments of the invention include a system comprising a film including a pigment configured to from a graphic; a first adhesive disposed near an interior of a first side of the film and configured for removal of the film from a mount surface; a second adhesive disposed proximate to outer edges of the first side of the cover layer, the second adhesive being characterized by a greater adhesion than the first adhesive and being disposed to come in contact with the mount surface.

Various embodiments of the invention include a method comprising adding a pigment to a first film layer or a second film to form a graphic; sizing the first film; adding a first adhesive to the first film, the first adhesive configured for the first film to be removable; sizing the second film to a width greater than the width of the first film; adding a second adhesive to the second film, the second adhesive having a greater adhesion than the first adhesive; and bonding the first film and the second film such that both the first adhesive and the second adhesive are disposed to adhere to a mount surface.

Various embodiments of the invention include a method comprising the steps of attaching one or more polymer layers to a mount surface using a first adhesive and a second adhesive, the first adhesive having a weaker adhesion per square centimeter relative to the second adhesive, the first adhesive being disposed near an interior of the attached layers, the second adhesive being disposed near a perimeter of the attached layers, and the one or more polymer layers including a pigment disposed to form a graphic; breaching the one or more layers in an area where the one or more layers are attached to the mount surface by the first adhesive; and removing the one or more layers starting at the breach.

### BRIEF DESCRIPTION OF THE DRAWINGS

FIG. 1 illustrates an example of a polymer film and an adhesive, according to various embodiments of the invention.

FIG. 2 illustrates a side view of a system comprising a media layer and a cover layer, according to various embodiments of the invention.

FIG. 3 illustrates a top view of the system of FIG. 2, according to various embodiments of the invention.

FIG. 4 illustrates a cross-sectional view of the system of FIG. 2 attached to a handrail, according to various embodiments of the invention.

FIG. 5 illustrates methods of generating a system comprising a media layer and a cover layer, according to various embodiments of the invention.

FIG. 6 illustrates a method of attaching and removing a film, according to various embodiments of the invention.

### DETAILED DESCRIPTION

A polymer film included in some embodiments of the invention comprises between 50 and 97 percent polyvinyl chloride, a more elastic and/or flexible polymer such as polyurethane or polyethylene, and optional pigments. This film is configured to resist discoloration due to contact with oils, plasticizers, rubber, and/or the like. For example, the film may be configured to resist discoloration from contact with styrene-butadiene rubber. In alternative embodiments the percentage of polyvinyl chloride is by weight between 80 and approximately 90 percent, 75 percent and 93 percent, 85 and 95 percent, at least 75 percent, at least 80 percent, at least 85 percent, approximately 85 percent, approximately 88 percent, approximately 90 percent, or approximately 92 percent. The polymer film may be between 1 and 20 thousandths, between 2 and 8 thousandths, or between 3 and 5 thousandths of an inch thick. A wide variety of polymer formulations and thicknesses may be used. In some embodiments, a formulation is selected to produce a desired flexibility and/or characteristics that protect against discoloration.

The polymer film optionally includes an adhesive disposed on at least one side. This adhesive is optionally acrylic or rubber. In some embodiments, this adhesive has an adhesion between 0.10 kg/cm and 1.5 kg/cm.

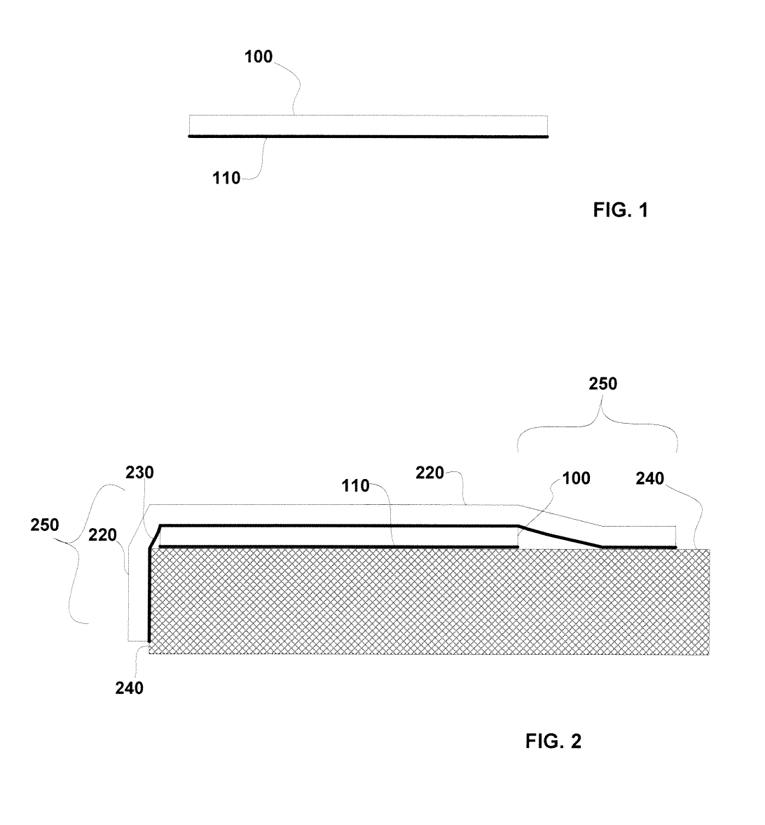

FIG. 1 illustrates an example of the polymer film and adhesive, according to various embodiments of the invention. This polymer film and adhesive are referred to as Media Layer 100 and First Adhesive Layer 110, respectively. Media Layer 100 may include for example, acrylic, polyurethane, polyethylene, polyvinyl chloride, and/or the like. For example, in some embodiments, Media Layer 100 consists primarily of polyurethane. FIG. 1 is not necessarily to scale. For example, Media Layer 100 may be 130 microns (10-6 meters) thick while First Adhesive Layer 110 may be less than 10 microns thick. In various embodiments, First Adhesive Layer 110 covers less than 100 percent of one side of Media Layer 100. In various embodiments, First Adhesive Layer 110 has an adhesion between 0.25 and 0.75 kg/cm, between 0.25 and 0.6 kg/cm, or between 0.4 and 0.6 kg/cm. An adhesion of 0.51 kg/cm ±0.10 kg/cm provides for removability of Media Layer 100.

Media Layer 100 typically includes one or more pigments that are optionally disposed to form a meaningful symbol or graphic, e.g., an advertisement. The pigments may be on or within Media Layer 100. In some embodiments, the pigments include titanium oxide and/or comprise between 1 and 7 percent of the Media Layer 100 by weight. For example, some embodiments include approximately 5 percent titanium oxide within the bulk of Media Layer 100 and further pigments disposed on a surface of Media Layer 100 to form a graphic.

FIG. 2 illustrates a side view of a system comprising a Media Layer 100 and a Cover Layer 220, according to various embodiments of the invention. Cover Layer 220 is typically transparent and configured to cover all or part of Media Layer 100. Typically, Cover Layer 220 comprises a polymer that is more elastic and/or flexible and includes a lower concentration of polyvinyl chloride relative to Media Layer 100. For example, in some embodiments, Cover Layer 220 comprises polyurethane or polyethylene and does not include an appreciable amount of polyvinyl chloride. Cover Layer 220 may be between 10 and 1000 microns thick. For example, in various embodiments, Cover Layer 220 is between 50 and 500, between 100 and 300, or between 150 and 250 microns thick. In some embodiments Cover Layer is approximately 200 microns thick. Cover Layer 220 is optionally bonded to Media Layer 100 by a thermal process and/or using an adhesive.

Cover Layer 220 is optionally larger in area than Media Layer 100. For example, Cover Layer 220 may be wider and/or longer than Media Layer 100. FIG. 2 illustrates an embodiment of Cover Layer 220 that includes Excess Width 250 that extends past edges of Media Layer 100. In various embodiments, Excess Width 250 is at least 3, 5, 8, 10, 13 or 15 millimeters in length. Excess Width 250 may be disposed on one, two, three, four or more sides of Media Layer 100. Cover Layer 220 is optionally stain resistant and may serve as an anti-graffiti coating. In some embodiments, an edge of Cover Layer 220 is less visible than an edge of Media Layer 100. This may reduce vandalism.

A Second Adhesive Layer 230 is disposed on at least one side of Cover Layer 220 and optionally includes an adhesive that is stronger than that of First Adhesive Layer 110. As such, Second Adhesive Layer 230 is optionally characterized by a greater adhesion, per square centimeter, than First Adhesive Layer 110. Second Adhesive Layer 230 is optionally disposed, in part, between Media Layer 100 and Cover Layer 220 and, as such, may contribute to the bonding of Media Layer 100 to Cover Layer 220. Second Adhesive Layer 230 optionally covers less than 100 percent of one side of Cover Layer 220. For example, in some embodiments, Second Adhesive Layer 230 is disposed on Excess Width 250 but not other parts of Cover Layer 220. In another example, in some embodiments, Second Adhesive Layer 230 is disposed on at least 80 percent of Excess Width 250. Second Adhesive Layer 230 can include, for example, a rubber or acrylic adhesive. Second Adhesive Layer 230 optionally has an adhesion of between 0.10 and 2.0 kg/cm. For example, Second Adhesive Layer 230 may have an adhesion between 0.25 and 1.50, between 0.5 and 1.0, or between 0.7 and 0.9 kg/cm. Second Adhesive Layer 230 is optionally less than one thousandths of an inch thick. A pigment is optionally disposed on the second film on the same sides as the Second Adhesive Layer 230, i.e., the side adjacent to Media Layer 100. For example, a pigment may be viewed through transparent material of the Cover Layer 220. This pigment is optionally printed as a reversed image.

Both First Adhesive Layer 110 and Second Adhesive Layer 230 are disposed to contact a Mount Surface 240 on which Media Layer 100 and Cover Layer 220 are mounted. Because Second Adhesive Layer 230 may provide a greater adhesion than First Adhesive Layer 110, the perimeter of the system illustrated in FIG. 2, e.g., Excess Width 250 and/or excess length, may be held more securely to Mount Surface 240 than parts of Media Layer 100. In some embodiments, this feature is used to facilitate the removal of Media Layer 100 and Cover Layer 220 from Mount Surface 240. Mount Surface 240 may include, for example, a floor, step, handrail, wall, vehicle, conveyor, electronic device, container, ceiling, roof, billboard, display case, supermarket checkout stand conveyor, poster, or the like. Mount Surface 240 is optionally flexible and optionally includes rubber, polyurethane styrene butadiene rubber, or the like.

Media Layer 100 and Cover Layer 220 may be attached to the same plane of Mount Surface 240, as shown in the right side of FIG. 2. Alternatively, Cover Layer 220 may extend around a corner or edge of Mount Surface 240, as shown in the left side of FIG. 2. In some embodiments, an edge of Media Layer 100 is disposed proximate to but not across a corner/edge while Cover Layer 220 overlays the corner/edge. The corner may be slight, or more than 90 degrees. In some embodiments, Cover Layer 220 is used to overlay an edge of approximately 180 degrees.

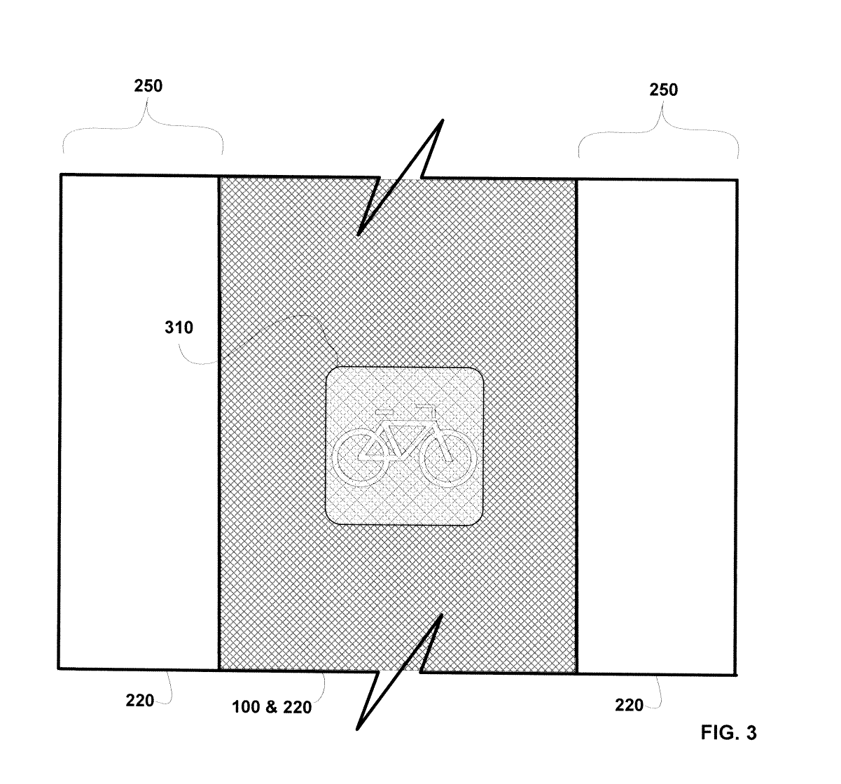

FIG. 3 illustrates a top view of the system of FIG. 2, according to various embodiments of the invention. The area occupied by both Media Layer 100 and Cover Layer 220 is shown as cross-hatched while the parts of Cover Layer 220 included within Excess Width 250 are not cross-hatched. While FIG. 3 illustrates a segment of what could be a long strip, in alternative embodiments, Excess Width 250 may be on one, two, three, four or more sides of Media Layer 100. In some embodiments, Excess Width 250 forms a curve or ring around Media Layer 100. Media Layer 100 optionally includes a Graphic 310 visible in the view illustrated in FIG. 3.

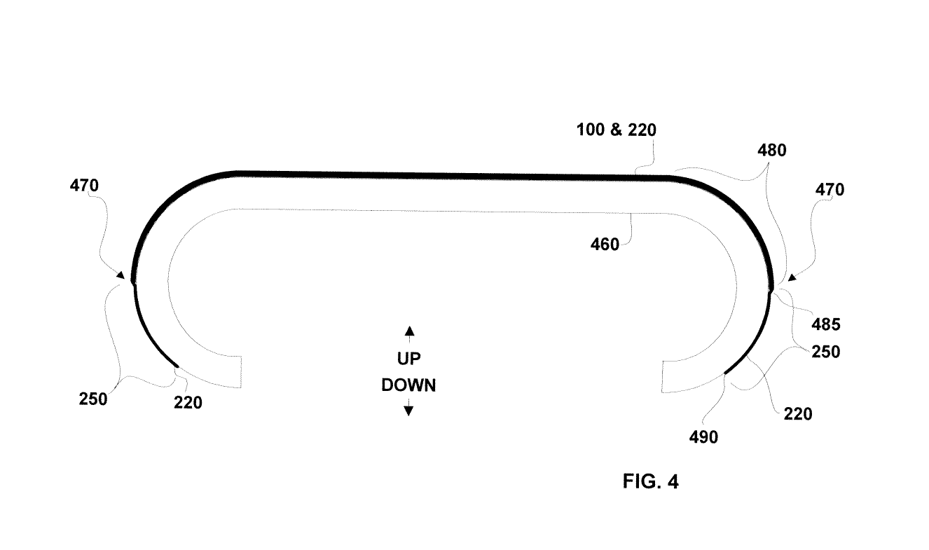

FIG. 4 illustrates a cross-sectional view of the system of FIG. 2 attached to a Handrail 460, according to various embodiments of the invention. Handrail 460 may be part of a moving device such as an escalator, elevator or moving sidewalk, or a stationary device such as a stairway railing, support railing or walkway railing. Handrail 460 is characterized by an Apex 470 on either side of Handrail 460. Apex 470 are the points of Handrail 460 on the far right and tar left as shown in FIG. 4. Media Layer 100 is disposed between Handrail 460 and parts of Cover Layer 220, while those parts of Cover Layer 220 that include Excess Width 250 are in contact with Handrail 460. Optionally Media Layer 100 is bound to Handrail 460 by First Adhesive Layer 110, while Excess Width 250 is bound to Handrail 460 by Second Adhesive Layer 230.

When Handrail 460 flexes to curve up or down, such as at the top and bottom of an escalator, then a part of Handrail 460 above or below each Apex 470 is compressed while that part of Handrail 460 on the other side of each Apex 470 is stretched. For example, if Handrail 460, as shown in FIG. 4, is extended out of the plane of the figure and then flexed down, then the region of Handrail 460 in contact with Excess Width 250 is compressed while a Region 480 is stretched. If the Handrail 460 is flexed up, then the region of Handrail 460 in contact with Excess Width 250 is stretched while Region 480 is compressed.

In some embodiments, an Edge 485 of Media Layer 100 is disposed approximately at or above Apex 470, e.g., in Region 480. In contrast, an Edge 490 of Excess Width 250 is disposed below Apex 470. If Handrail 460 is flexed, Cover Layer 220 is subject to both stretching and compression, while Media Layer 100 is predominately stretched or predominantly compressed, but not both stretched and compressed significantly at the same time. As such when Handrail 460 is flexed, Cover Layer 220 is subject to a greater total amount of stretching and compression than is Media Layer 100.

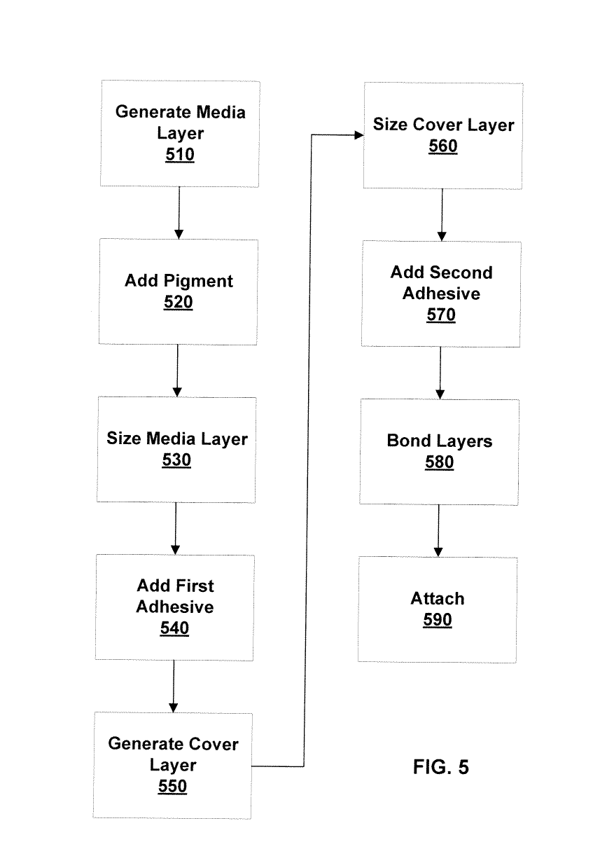

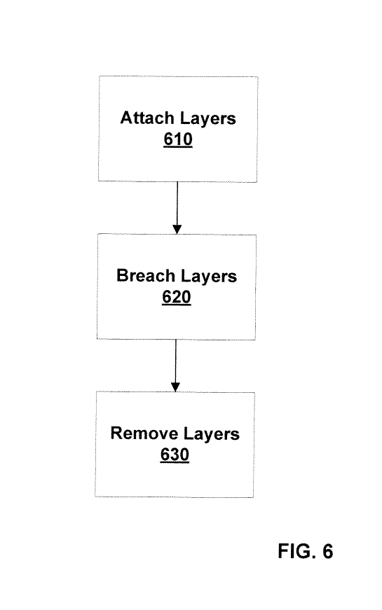

FIG. 5 illustrates methods of generating a system comprising Media Layer 100 and Cover Layer 220, according to various embodiments of the invention. In these methods Media Layer 100 and Cover Layer 220 are combined to form the film illustrated in FIG. 2. This film may be attached to a railing or other Mount Surface 240.

In an optional Generate Media Layer Step 510, Media Layer Step 510 is generated. In some embodiments, this is accomplished by extruding or depositing a mixture of polymers and pigment. In some embodiments these polymers include the various polymer mixtures discussed elsewhere herein. For example, Media Layer 100 may be generated by extruding a polymer mixture including at least 75 percent by weight polyvinyl chloride. Generate Media Layer Step 510 is optional in embodiments where in Media Layer 100 is received from another party.

In an optional Add Pigment Step 520, one or more pigments are added to Media Layer 100. In various embodiments pigments added may be at much of 10, 7, 6, 5, 4, 3 or 2 percent of Media Layer 100 by weight. Pigments can be added during Generate Media Layer Step 510 or applied to Media Layer 100 after extrusion. Pigments may be applied to Media Layer 100 before Media Layer 100 cools completely from the extrusion process. Pigments may be added using silkscreen, printing, lithographic, ecosolvent, electrostatic, photographic, or other image generating processes known in the art. The pigments are optionally disposed to form a solid color or graphic such as alphanumeric characters, symbols, words, images, pictures, trademarks, logos, and/or the like. In some embodiments, Titanium Oxide (TiO₂) is included in the bulk of the polymer film and further pigments are then deposited on a surface of the polymer film. Add Pigment Step 520 is optional in embodiments wherein the color of the polymers that comprise Media Layer 100 is a desired color.

In a Size Media Layer Step 530, Media Layer 100 is sized to desired dimensions. Sizing is accomplished by, for example, adjusting an extrusion process to generate Media Layer 100 at a desired size in Generate Media Layer Step 510 or by cutting Media Layer 100 to a desired size from a larger piece. For example, in some embodiments, the output of Generate Media Layer Step 510 is cut into one or more strips having a desired width. Several strips may be cut in parallel. A sized width of Media Layer 100 is optionally configured to fit between apex points of a moving handrail. In some embodiments, Size Media Layer Step 530 includes measuring a surface distance between Apex 470 of a flexible handrail. In various embodiments, the width of Media Layer 100 is sized to between 12.5 and 6 cm, between 9 and 11 cm, or between 10 and 11 cm. For example, Media Layer 100 may be approximately 10.5 cm wide and at least 3, 4, 5 or 10 times longer than it is wide. In alternative embodiments Media Layer 100 is greater than 12.5 or 25 cm wide, for example Media Layer 100 may be between 50 and 80 cm wide.

In an Add First Adhesive Step 540, a first adhesive is added to at least one side of Media Layer 100. This adhesive may be, for example, whipped, flowed, knifed, transferred using tape, sprayed or brushed on and may include any to the adhesives discussed elsewhere herein. In some embodiments, the first adhesive added in Add First Adhesive Step 540 is configured for both attachment and later removal of Media Layer 100 from Mount Surface 240. Media Layer 110 may include a temporary liner configured to protect the first adhesive. The liner is optionally added following Add First Adhesive Step 540 in a step not shown in FIG. 5. The liner is optionally of a larger dimension than Media Layer 100.

In an optional Generate Cover Layer Step 550, Cover Layer 220 is generated. Cover Layer 220 is typically, generated by extrusion or depositing one or more polymers. In some embodiments, Cover Layer 220 is deposited or extruded directly onto Media Layer 100. Generate Cover Layer Step 550 is optional in embodiments where Cover Layer 220 is received from another party.

In a Size Cover Layer Step 560, Cover Layer 220 is sized to a dimension that is optionally greater than that of Media Layer 100. For example, Cover Layer 220 may be sized to a greater width and/or a greater length than Media Layer 100. Sizing may occur by cutting Cover Layer 220 or by, for example, adjusting an extrusion process to generate Cover Layer 20 at a desired size in Generate Cover Layer Step 550. In some embodiments, several of Cover Layer 220 are cut in parallel from one or more starting pieces. In some embodiments, Cover Layer 220 is sized to a dimension of the liner of Media Layer 100.

In an Add Second Adhesive Step 570, a second adhesive is added to Cover Layer 220. This second adhesive is optionally different than the first adhesive added in Add First Adhesive Step 540. In some embodiments, the second adhesive is configured to have a greater adhesion than the first adhesive. As such, the Cover Layer 220 may be more firmly bonded to Mount Surface 240 than Media Layer 100. In some embodiments, the liner of Media Layer 100 is configured to temporarily protect both the first adhesive and the second adhesive.

In an optional Bond Step 580, Media Layer 100 and Cover Layer 220 are bonded together. Typically, they are disposed relative to each other such that Excess Width 250 is disposed beyond one, two or more edges of Media Layer 100. Cover Layer 220 is added to a side of Media Layer 100 opposite the first adhesive added in Add First Adhesive Step 540. As such, both the first adhesive and the second adhesive are disposed to adhere to the same Mount Surface 240. Bonding may be accomplished using the second adhesive added in Add Second Adhesive Step 570, using another adhesive, using a thermal bonding process, and/or the like.

In an optional Attach Step 590, Media Layer 100 and Cover Layer 220 are attached to Mount Surface 240 using the first adhesive and the second adhesive. This attachment may be performed manually or automatically. In some embodiments, Attach Step 590 includes positioning Media Layer 100 between Apex 470, and positioning part of Excess Width 250 over Apex 470.

It will be obvious to one of ordinary skill in the art, with the benefit of this disclosure, that the steps of FIG. 5 may be performed in wide variety of alternative orders. For example, Add Pigment Step 520 may be performed before or after Size Media Layer Step 530. Likewise Add First Adhesive Step 540 and or Add Second Adhesive Step 570 could be performed after Bond Step 580. If Bond Step 580 occurs before the addition of adhesives, then the positions of the adhesives need not match the respective positions of Media Layer 100 and Excess Width 250. For example, in some embodiments, the second adhesive may be disposed on only part of Excess Width 250, or the second adhesive may be also disposed on part of Media Layer 100. In some embodiments, both the first and second adhesives are added in different positions at the same time. In some embodiments, Bond Step 580 occurs after Media Layer 100 has been attached to Mount Surface 240.

FIG. 6 illustrates a method of attaching and removing a film, according to various embodiments of the invention. In this method a film, e.g., a polymer display film is attached using one or more adhesives disposed in different locations. For example, a stronger adhesive may be disposed around a perimeter of the film while a weaker adhesive is disposed in the interior. The film is removed by first breaching the film to access a region where the weaker adhesive is used and then beginning separation of the film from the surface to which the film is attached at the site of the breach. The display film is optionally attached to a surface configured to move, such as a moving handrail. The film may include one layer or a plurality of layers, such as those illustrated in FIG. 2 and/or discussed elsewhere herein.

In an Attach Layers Step 610, Media Layer 100 and/or Cover Layer 220 are attached to a Mount Surface 240 using more than one adhesive, a first of the more than one adhesive having a weaker adhesion per square centimeter than a second of the more than one adhesive, and the first adhesive being disposed near an interior of the attached layer(s) while the second adhesive is disposed near a perimeter of the attached layer(s). For example, of the second adhesive may be disposed around all or part of a perimeter of a rectangular area while the first adhesive is disposed within a central of the rectangular area.

In a Breach Layers Step 620, the Media Layer 100 and/or Cover Layer 220 are breached. This breach may include for example cutting, tearing, melting, or the like of Media Layer 100 and/or Cover Layer 220. The breach is made in an area wherein Media Layer 100 and/or Cover Layer 220 are attached to Mount Surface 240 using the first (weaker) adhesive. The breach is configured to such that Media Layer 100 and/or Cover Layer 220 can be separated from Mount Surface 240 starting at an area where they are attached using the first adhesive rather than the second (stronger) adhesive.

In a Remove Layers Step 630, the Media Layer 100 and/or Cover Layer 220 are removed from Mount Surface 240 starting at the breach made in Breach Layers Step 620. The removal is begun at a point where Media Layer 100 and/or Cover Layer 220 are attached using the first adhesive rather than the second adhesive.

Several embodiments are specifically illustrated and/or described herein. However, it will be appreciated that modifications and variations are covered by the above teachings and within the scope of the appended claims without departing from the spirit and intended scope thereof. For example the combination of different sized media and cover layers does not require a polymer that is resistant to discoloring when in contact with styrene-butadiene rubber. The use of different adhesives on the media layer and cover layer do not require a polymer that is resistant to discoloring when in contact with styrene-butadiene rubber. In alternative embodiments pigments are added to Cover Layer 220 and Media Layer 100 may or many not include pigments. In these embodiments, Media Layer 100 optionally functions as merely a barrier to prevent discoloration, to protect Mount Surface 240, and/or the like. In some embodiments pigments are included in both Media Layer 100 and Cover Layer 220.

Some embodiments of the system illustrated in FIG. 2 include more than one Media Layer 100. For example, two or more different Media Layers 100 may be used to create different colors or patterns. Some of these Media Layers 100 may comprise openings or patterns though which other layers may be observed.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A system comprising:
a first polymer film;
a second polymer film attached to the first film, the second polymer film having a width or length that is greater than a width or length of the first polymer film, respectively;
a pigment disposed on the first polymer film or the second polymer film; and
a first adhesive disposed on at least one side of the first film and configured to removably attach the first film to a mount surface.

2. The system of claim 1, wherein the first polymer film includes at least 75 percent by weight of polyvinyl chloride.

3. The system of claim 1, wherein the first polymer film is configured to fit between apex points of a conveyance handrail.

4. The system of claim 3, wherein the second polymer film is configured to extend past the apex points of the conveyance handrail.

5. The system of claim 1, wherein the second polymer film is at least one centimeter wider than the first polymer film.

6. The system of claim 1, wherein the second polymer film includes polyurethane or polyethylene.

7. The system of claim 1, wherein the second polymer film is transparent and the pigment is disposed on the first polymer film.

8. The system of claim 1, wherein the second polymer film is between 150 and 250 microns thick.

9. The system of claim 1, wherein the first polymer film is attached to the second polymer film using a second adhesive, the second adhesive having a greater adhesion than the first adhesive.

10. The system of claim 1, wherein the first polymer film has a length that is at least 5 times greater than the width of the first polymer film.

11. The system of claim 1, further including a second adhesive disposed on the second polymer film such that both the first adhesive and the second adhesive can come in contact with the mount surface, the second adhesive having a greater adhesion than the first adhesive.

12. The system of claim 1, further including a conveyance handrail that includes the mount surface.

13. A method comprising:
adding a pigment to a media layer or a cover layer;
sizing the media layer to a width configured to fit between apex points of a conveyance handrail;
adding a first adhesive to the media layer, the first adhesive configured for the media layer to be removable;
sizing a cover layer to a width greater than the width of the media layer; and
bonding the media layer and the cover layer.

14. The method of claim 13, wherein the pigment is disposed to form a graphic.

15. The method of claim 13, further comprising mixing polyvinyl chloride, and polyurethane or polyethylene to generate the media layer, the media layer including at least 75 percent by weight polyvinyl chloride.

16. The method of claim 13, wherein the width of the cover layer is at least one centimeter greater than the width of the media layer.

17. The method of claim 13, wherein the adhesion of the first adhesive is less than or equal to 0.7 kg/cm.

18. The method of claim 13, further comprising attaching the media layer and the cover layer to the conveyance handrail after the media layer has been attached to the cover layer.

19. The method of claim 18, wherein the attached media layer is disposed approximately between the apex points and the attached cover layer extends across the apex points.

20. The method of claim 13, further including adding a second adhesive to the cover layer, the second adhesive having a greater adhesion than the first adhesive and being disposed to adhere to the conveyance handrail.

21. The method of claim 13, further including measuring a distance between the apex points of the conveyance handrail.

22. A system comprising:
a first polymer film having a width between approximately 11 cm and 9 cm;
a second polymer film attached to the first film, the second polymer film being transparent and having a width greater than the width of the first polymer film;
a pigment disposed on the first polymer film or the second polymer film so as to form a graphic; and
a first adhesive disposed on at least one side of the first film and configured to removably attach the first film to a conveyance handrail.

23. The system of claim 22, wherein the first polymer film comprises a different polymer formula than the second polymer film.

24. The system of claim 1, wherein the second polymer film is configured to cover most of a region 480 illustrated in FIG. 4.

25. The method of claim 13, wherein sizing the media layer includes cutting the media layer.

26. The method of claim 13, wherein the media layer is sized to cover at least part of a region 480 illustrated in FIG. 4.

27. The method of claim 13, wherein the cover layer is sized to extend past the apex points.
